(19) United States
(12) Patent Application Publication
(10) Pub. No.: US 2026/0084421 A1
(43) Pub. Date: Mar. 26, 2026

(54) LIQUID EJECTION DEVICE AND INK JET HEAD

(71) Applicant: RISO Technologies Corporation, Tokyo (JP)

(72) Inventor: Ryutaro KUSUNOKI, Mishima Shizuoka (JP)

(21) Appl. No.: 19/219,962

(22) Filed: May 27, 2025

(30) Foreign Application Priority Data
Sep. 25, 2024 (JP) 2024-166374

(51) Int. Cl. B41J 2/045; B41J 2/14

(52) U.S. Cl. CPC B41J 2/04588; B41J 2/04573; B41J 2/04581; B41J 2/0459; B41J 2/14274; B41J 2/1433; B41J 2002/14491; B41J 2202/07

(57) ABSTRACT

A liquid ejection device includes a nozzle, a pressure chamber, a volume of which is varied to eject liquid from the nozzle, a piezoelectric element configured to vary the volume in response to a drive signal, and a drive circuit configured to generate the drive signal that includes a first ejection waveform, a first holding waveform subsequent to the first ejection waveform, a second ejection waveform subsequent to the first holding waveform, a second holding waveform subsequent to the second ejection waveform, a contraction waveform subsequent to the second holding waveform, a third ejection waveform subsequent to the contraction waveform, and a third holding waveform subsequent to the third ejection waveform. A time between the centers of the second and third ejection waveforms is longer than a time between the centers of the first and the second ejection waveforms.

### CROSS-REFERENCE TO RELATED APPLICATION

This application is based upon and claims the benefit of priority from Japanese Patent Application No. 2024-166374, filed on Sep. 25, 2024, the entire contents of which are incorporated herein by reference.

### FIELD

Embodiments described herein relate generally to a liquid ejection device and an ink jet head.

### BACKGROUND

As a drive signal of a piezoelectric ink jet recording device, a technique exists in which a pulse that expands the volume of a pressure chamber is applied to an actuator at a constant cycle of 2 ALs to continuously eject ink droplets, where AL is half of the main acoustic resonance cycle of the ink in the pressure chamber. Since the droplets are ejected in a cycle of 2 ALs, the drive time is short and the drive frequency can be easily improved, but when three or more droplets are ejected, air bubbles are likely to form at the nozzle, which can lead to ejection failure.

### BRIEF DESCRIPTION OF THE DRAWINGS

FIG. 1 is a cross-sectional view illustrating a structure of an ink jet head according to a first embodiment.

FIG. 2 is a cross-sectional view illustrating a structure of the ink jet head.

FIG. 3 is a waveform diagram illustrating a drive waveform.

FIG. 4 is a waveform diagram illustrating a drive waveform according to a comparative example.

FIG. 5 is a table illustrating simulation results for air bubble occurrence in driving according to the first embodiment and driving according to the comparative example.

FIG. 6 is a diagram illustrating a modification of a nozzle shape.

FIG. 7 is a waveform diagram illustrating a drive waveform according to a second embodiment.

### DETAILED DESCRIPTION

Embodiments of this disclosure provide a liquid ejection device and an ink jet head capable of improving ejection performance.

In general, according to one embodiment, a liquid ejection device comprises a nozzle, a pressure chamber that is capable of storing liquid and communicates with the nozzle, a volume of the pressure chamber being varied to eject the liquid from the nozzle, a piezoelectric element configured to vary the volume of the pressure chamber in response to a drive signal, and a drive circuit configured to generate the drive signal. The drive signal includes: a first ejection waveform that causes the liquid to be ejected from the nozzle, a first holding waveform that is subsequent to the first ejection waveform and maintains the volume of the pressure chamber for a first time period, a second ejection waveform that is subsequent to the first holding waveform and causes the liquid to be ejected from the nozzle, a second holding waveform that is subsequent to the second ejection waveform and maintains the volume of the pressure chamber for a second time period, a contraction waveform that is subsequent to the second holding waveform and contracts the pressure chamber, a third ejection waveform that is subsequent to the contraction waveform and causes the liquid to be ejected from the nozzle, and a third holding waveform that is subsequent to the third ejection waveform and maintains the volume of the pressure chamber for a third time period, and a time between the center of the second ejection waveform and the center of the third ejection waveform is longer than a time between the center of the first ejection waveform and the center of the second ejection waveform.

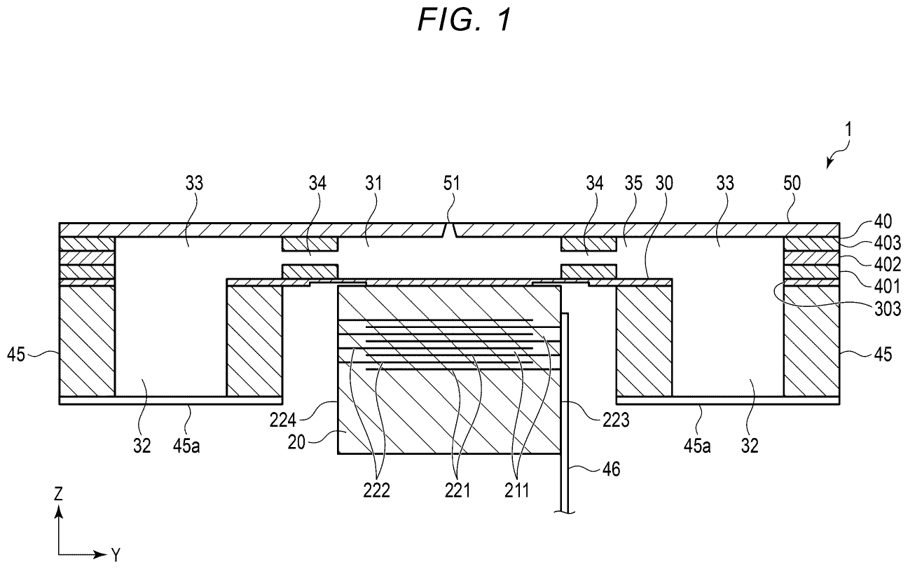

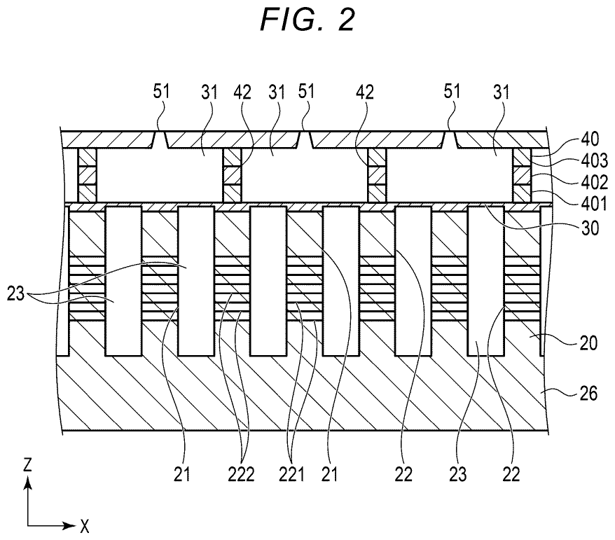

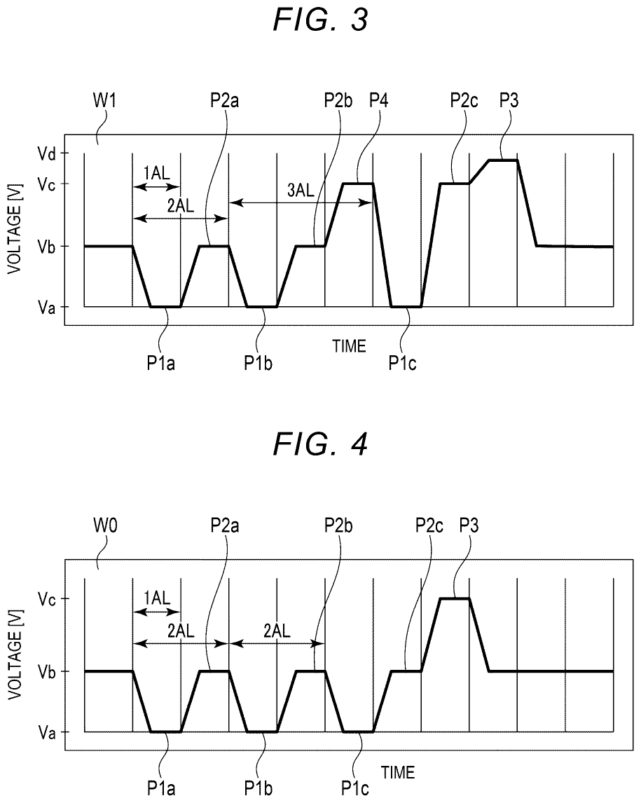

Hereinafter, an ink jet head 1 according to a first embodiment will be described with reference to FIGS. 1 to 3. FIGS. 1 and 2 are cross-sectional views illustrating a structure of the ink jet head 1 according to the first embodiment. FIG. 3 is a waveform diagram illustrating a drive waveform according to the first embodiment. In the drawings, a structure is illustrated enlarged, reduced, or omitted as appropriate for the purpose of description.

FIGS. 1 and 2 are a longitudinal cross-sectional view and a transverse cross-sectional view illustrating the ink jet head 1 according to the present embodiment. The ink jet head 1 which is an example of a drive device includes an actuator portion 20, a vibration plate 30, a flow path substrate 40 including a plurality of flow path plates, a nozzle plate 50 including a plurality of nozzles 51, a frame portion 45, and a drive circuit 46. The ink jet head 1 is a liquid ejection head provided in a liquid ejection device such as an ink jet recording device.

The actuator portion 20 is formed of, for example, a piezoelectric member, and includes a plurality of drive piezoelectric elements 21 and a plurality of non-drive piezoelectric elements 22 serving as actuators alternately arranged along a row direction, and a piezoelectric structure portion 26 that integrally couples the plurality of piezoelectric elements 21 and 22. The actuator portion 20 is divided into a plurality of portions by a plurality of grooves 23, and the plurality of drive piezoelectric elements 21 and the plurality of non-drive piezoelectric elements 22 are formed side by side in the row direction at the same pitch. The plurality of drive piezoelectric elements 21 and the plurality of non-drive piezoelectric elements 22 are formed in rectangular columnar shapes having the same outer shape.

Piezoelectric members constituting the drive piezoelectric elements 21 and the non-drive piezoelectric elements 22 are, for example, stacked piezoelectric bodies. Each of the drive piezoelectric element 21 and the non-drive piezoelectric element 22 includes a plurality of stacked piezoelectric layers 211 and internal electrodes 221 and 222 formed on main surfaces of the piezoelectric layers 211. For example, the drive piezoelectric element 21 and the non-drive piezoelectric element 22 have the same stacked structure. Each of the drive piezoelectric element 21 and the non-drive piezoelectric element 22 includes external electrodes 223 and 224 formed on surfaces of the piezoelectric element.

The piezoelectric layer 211 is formed of a piezoelectric material such as a lead zirconate titanate (PZT) based material or a lead-free sodium potassium niobate (KNN) based material. The plurality of piezoelectric layers 211 are stacked in a thickness direction along a stacking direction. For example, in the present embodiment, the thickness direction and the stacking direction of the piezoelectric layers 211 are along a vibration direction (i.e., a Z direction).

The internal electrodes 221 and 222 are conductive films formed in a predetermined shape and formed of a sinterable conductive material such as silver palladium. The internal electrodes 221 and 222 have different poles. For example, the internal electrode 221 is formed in a region reaching one end portion of the piezoelectric layer 211 and not reaching the other end portion of the piezoelectric layer 211 in an extension direction (i.e., a Y direction) orthogonal to both the vibration direction (i.e., the Z direction) and the row direction (i.e., an X direction) which is an arrangement direction of the plurality of drive piezoelectric elements 21 and the plurality of non-drive piezoelectric elements 22. The internal electrode 222 is formed in a region not reaching the one end portion of the piezoelectric layer 211 but reaching the other end portion of the piezoelectric layer 211 in the extension direction. The internal electrodes 221 and 222 are connected to the external electrodes 223 and 224 formed on side surfaces of the piezoelectric elements 21 and 22.

The external electrodes 223 and 224 are formed on surfaces of the plurality of drive piezoelectric elements 21 and the plurality of non-drive piezoelectric elements 22, and are formed by collecting ends of the internal electrodes 221 and 222. For example, the external electrode 223 and the external electrode 224 are respectively formed on one end surface and the other end surface in the extension direction of the piezoelectric layer 211, and respectively serve as an individual electrode and a common electrode.

The external electrodes 223 and 224 are connected to a drive circuit via, for example, a wiring board.

In the ink jet head 1, the drive piezoelectric element 21 vibrates when a voltage is applied to the internal electrodes 221 and 222 from the wiring board via the external electrodes 223 and 224. In the present embodiment, the drive piezoelectric elements 21 perform longitudinal vibration along the stacking direction of the piezoelectric layers 211 to displace the vibration plate 30 and deform a pressure chamber 31.

The vibration plate 30 extends along a plane orthogonal to the Z direction which is a vibration direction, and is joined to one side in the vibration direction of the piezoelectric layers 211 of the plurality of piezoelectric elements 21 and 22, that is, a surface on a side close to the nozzle plate 50. The vibration plate 30 faces the plurality of nozzle 51 via the pressure chamber 31 in the Z direction which is the vibration direction. For example, the vibration plate 30 is configured to be deformable. The vibration plate 30 is joined to the drive piezoelectric elements 21 and the non-drive piezoelectric elements 22 of the actuator portion 20 and the frame portion 45. The vibration plate 30 is provided between a flow path plate 401 and the actuator portion 20 in the vibration direction. The vibration plate 30 is disposed in a manner of overlapping a plurality of flow path plates 401, 402, and 403, and constitutes a part of an ink flow path 35. The vibration plate 30 is joined to an end surface of the actuator portion 20 by adhesion or the like.

The flow path substrate 40 includes a plurality of the stacked flow path plates 401, 402, and 403. For example, the plurality of flow path plates 401, 402, and 403 having openings or grooves, the nozzle plate 50, and the vibration plate 30 are combined and joined to form the desired ink flow path 35 according to ink viscosity, a volume of the ink to be ejected, and the like. The plurality of flow path plates 401, 402, and 403 are stacked in the stacking direction, and the openings or grooves formed in the flow path plates 401, 402 and 403 form the predetermined ink flow path 35 including the pressure chambers 31 that communicate with the plurality of nozzles 51, individual liquid chambers 33 that communicate with common chambers 32, and throttle flow paths 34 (or resistance flow paths).

For example, the flow path plates 401, 402, and 403 are stacked in order from a side close to the vibration plate 30, and the flow path plate 403 is disposed in a manner of facing the nozzle plate 50.

The flow path substrate 40 is disposed between the nozzle plate 50 and the vibration plate 30. The flow path substrate 40 is formed by stacking and joining the plurality of flow path plates 401, 402, and 403 to form the predetermined ink flow path 35 including, therein, the plurality of pressure chambers 31, the individual liquid chambers 33 that communicate with the common chambers 32, and the plurality of throttle flow paths 34 extending from the individual liquid chambers 33 to the pressure chambers 31. In other words, the flow path substrate 40 is formed by the plurality of stacked flow path plates 401, 402, and 403, and includes a peripheral wall portion that surrounds the ink flow path 35 including the plurality of pressure chambers 31, the plurality of throttle flow paths 34, and the individual liquid chambers 33, and includes a plurality of partition wall portions 42 that partition rows of the plurality of pressure chambers 31, and side wall portions that partition the plurality of throttle flow paths 34.

The nozzle plate 50 is formed of a metal such as SUS and Ni, or a resin material such as polyimide, and has a rectangular plate shape with a thickness of about 10 μm to 100 μm. The nozzle plate 50 is disposed on one side of the flow path substrate 40 in a manner of covering an opening on one side of the pressure chamber 31. The nozzle plate 50 has the plurality of nozzles 51 that eject liquid droplets. The plurality of nozzles 51 are holes that pass through the nozzle plate 50 in the thickness direction. The plurality of nozzles 51 are arranged in an X direction the same as the arrangement direction of the pressure chambers 31 to form a nozzle row. The nozzles 51 are provided at positions corresponding to the plurality of pressure chambers 31.

The frame portion 45 is a structure joined to the vibration plate 30 together with the piezoelectric elements 21 and 22. The frame portion 45 is provided on a side of the vibration plate 30 opposite to the flow path substrate 40. For example, the frame portion 45 is adjacent to the actuator portion 20 in the present embodiment. The frame portion 45 is an outer shell of the ink jet head 1. The frame portion 45 is formed with a liquid flow path therein. In the present embodiment, the frame portion 45 is joined to the other side of the vibration plate 30, and the common chamber 32 is formed between the frame portion 45 and the vibration plate 30. For example, some walls of the frame portion 45 may be configured by deformable damper members 45a.

The common chamber 32 is formed inside the frame portion 45 and communicates with the pressure chamber 31 through an opening 303 provided in the vibration plate 30, the individual liquid chamber 33, and the throttle flow path 34.

The drive circuit 46 includes various wiring boards and a driver IC. The drive circuit 46 generates and outputs a drive waveform according to a drive signal applied to a drive element. The driver IC is electrically connected to electrodes of the actuator portion 20 via a wire of a wiring board. The drive circuit 46 outputs a drive signal to drive the actuator portion 20, increases or reduces a volume of the pressure chamber 31, and ejects a liquid droplet from the nozzle 51 facing the actuator portion 20.

In the ink jet head 1 formed as described above, the nozzle plate 50, the frame portion 45, the flow path substrate 40, and the vibration plate 30 form the ink flow path 35 including the plurality of pressure chambers 31 communicating with the nozzles 51, individual flow paths formed by the throttle flow paths 34 communicating with the plurality of pressure chambers 31, and the individual liquid chambers 33, and including the common chambers 32 serving as a common flow path. For example, the common chamber 32 communicates with a cartridge, and the ink is supplied to the pressure chambers 31 through the common chamber 32. All piezoelectric elements are connected so that a voltage can be applied to a wire. In the ink jet head 1, when the drive circuit 46 applies a drive voltage to the electrodes 221 and 222 in a state where ink is filled, the piezoelectric element 21 to be driven vibrates in the stacking direction, that is, a thickness direction of the piezoelectric layer 211. That is, the piezoelectric element 21 vibrates longitudinally. Specifically, the drive circuit 46 selectively drives the piezoelectric element 21 to be driven by applying a drive voltage to the internal electrodes 221 and 222 of the piezoelectric element 21. Then, the vibration plate 30 is deformed and the volume of the pressure chamber 31 is changed by the piezoelectric element 21 by combining deformation in a tensile direction and deformation in a compression direction, thereby guiding liquid from the common chamber 32 and ejecting the liquid from the nozzle 51.

Hereinafter, a drive waveform W1 according to the drive signal output by the drive circuit 46 will be described. FIG. 3 is a graph illustrating an example of a drive waveform. The drive waveform W1 according to the present embodiment has three drop waveforms in one printing cycle. In FIG. 3, a vertical axis represents voltage [V] and a horizontal axis represents time [μs]. Note that each waveform diagram is marked with grid lines at intervals of one acoustic length (AL). Here, AL is a time of a half of a natural vibration cycle (or a main acoustic resonance cycle) of ink in the pressure chamber 31 of the ink jet head 1.

The drive waveform W1 includes a plurality of ejection pulses P1a to P1c (hereinafter also referred to as ejection waveforms), holding elements P2a to P2c corresponding to holding times, a cancellation pulse P3 (hereinafter also referred to as a cancellation waveform), and a contraction pulse P4 (hereinafter also referred to as a contraction waveform).

The first ejection pulse P1a which is an ejection pulse for a first droplet is a pulse waveform for ejecting ink by reducing a voltage from a standby voltage Vb which is a reference voltage to an extended voltage Va which is lower than the standby voltage to expand the pressure chamber, and returning the voltage to the standby voltage Vb after a certain time. For example, the ejection pulse P1a is a trapezoidal pulse waveform.

The first holding element P2a which is a holding element for the first droplet has a waveform for maintaining the voltage for a predetermined time.

The second ejection pulse P1b which is an ejection pulse for a second droplet is a pulse waveform for ejecting ink by reducing the voltage from the standby voltage Vb to the extended voltage Va after the holding element P2a to expand the pressure chamber 31, and returning the voltage to the standby voltage Vb after a certain time. For example, the ejection pulse P1b is a trapezoidal pulse waveform.

The holding element P2b has a waveform for maintaining the voltage for a predetermined time.

In the ink jet head 1, when the ejection pulse P1a is applied to the actuator portion 20, the volume of the pressure chamber 31 is expanded and then contracted, pressure vibration at the time of expansion and pressure vibration at the time of contraction are superimposed, and the first droplet of ink is ejected from the nozzle 51 during the holding element P2a. When the ejection pulse P1b is applied at a timing after 2 ALs from the start of application of the ejection pulse P1a, the second droplet of ink is ejected during the holding element P2b.

The drive waveform W1 has the contraction pulse P4 after the holding element P2b and before the third ejection pulse P1c which is an ejection pulse for a third droplet. That is, at the time of ejecting the second droplet, the third droplet is not ejected immediately after the standby voltage is maintained, but a pulse waveform for contracting the pressure chamber is applied before the third ejection pulse P1c.

The contraction pulse P4 is a pulse waveform for increasing the voltage from the standby voltage of the second holding element P2b which is a holding element for the second droplet to a contraction voltage Vc higher than the standby voltage, and returning the voltage to the standby voltage Vb after a certain time.

For example, the ejection pulse P1c for the third droplet is applied after the contraction pulse P4. Here, the third ejection pulse P1c is a pulse waveform for reducing the voltage once to the extended voltage Va and then increasing the voltage to the contraction voltage Vc after a certain time. The ejection pulse P1c is applied at a timing after 3 ALs from the start of application of the ejection pulse P1b.

In the present embodiment, the cancellation pulse P3 is provided after the third holding element P2c which is a holding element after the ejection pulse P1c for the third droplet.

The cancellation pulse P3 is a waveform for increasing the contraction voltage Vc to a cancellation voltage Vd higher than the contraction voltage Vc after the holding element P2c for holding the contraction voltage Vc for a certain time after the ejection pulse P1c, and returning the voltage to the standby voltage Vb after a certain time. The application of the cancellation pulse P3 attenuates residual vibration.

In the drive waveform W1, a time (or a cycle) between the ejection pulse P1a and the ejection pulse P1b is twice AL, that is, 2 ALs. On the other hand, a time between the ejection pulse P1b and the ejection pulse P1c is three times AL, that is, 3 ALs. That is, a cycle between ejection waveforms for the second drop and the third drop is longer than a cycle between ejection waveforms for the first drop and the second drop. The predetermined times for the holding elements P2a, P2b, and P2c may or may not be identical. In one embodiment, those predetermined times are shorter than 1 AL.

According to the drive device in the present embodiment, the ejection performance can be improved by preventing trapping in the nozzle. That is, in the drive waveform W1, the meniscus can be stabilized by applying the contraction pulse P4 before the application of the ejection pulse P1c for the third droplet, and an ejection failure can be prevented by applying the ejection pulse P1c after the contraction pulse P4.

For example, in a comparative example, a drive waveform W0 illustrated in FIG. 4 is a waveform for applying the ejection pulse P1c for the third drop immediately after the end of the holding time P2b. That is, the drive waveform W0 applies the ejection pulse P1c without applying the contraction pulse P4 after the end of the holding time P2b. When an ink ejection operation is performed at this timing, air bubbles occur in the ink meniscus in the nozzle 51, and an ejection failure is likely to occur.

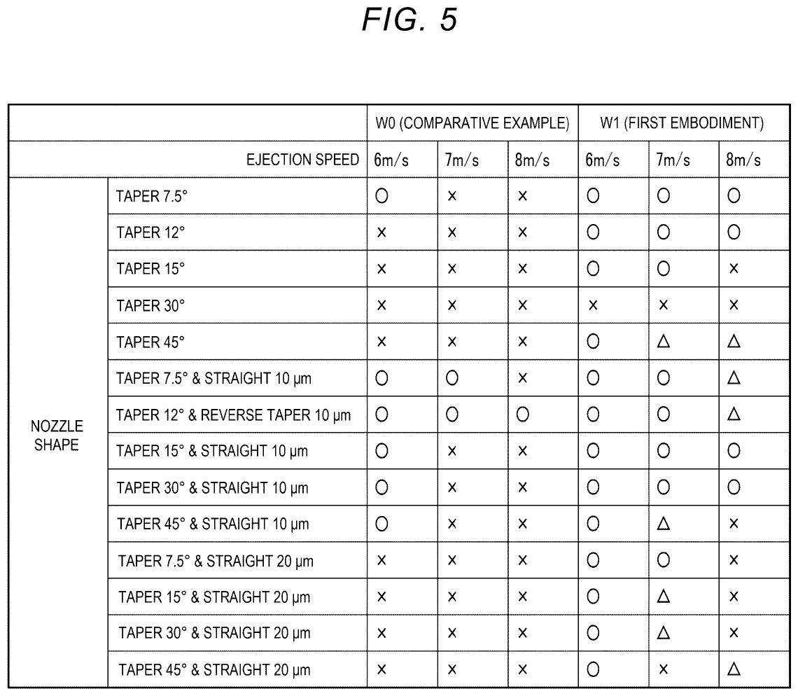

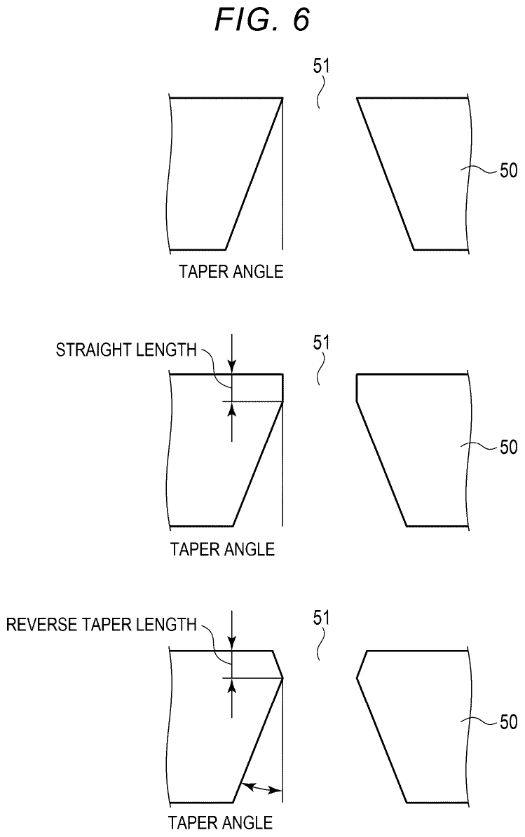

FIG. 5 illustrates a comparison of simulation results of air bubble occurrence between the drive waveform W1 according to the embodiment illustrated in FIG. 3 and the drive waveform W0 according to the comparative example illustrated in FIG. 4. For each of the waveforms W1 and W0, an ink ejection simulation was performed under conditions of ejection speeds of 6 m/s, 7 m/s, and 8 m/s for nozzles having various shapes illustrated in FIG. 6 serving as nozzle shapes. The ink ejection simulation was performed using a nozzle having a shape in which a taper angle of the nozzle was changed, a shape in which a taper was provided and a tip end on an ejection surface side was straight, and a shape in which a taper was provided and a tip end on an ejection surface side was reversely tapered. A length of a straight portion was 10 μm or 20 μm. An ink viscosity in the ink ejection simulation was 5 mPa·s. A case where there is no air bubble in a nozzle is indicated by O, a case where air bubbles occur is indicated by x, and a case where air bubbles are likely to occur is indicated by Δ. As illustrated in FIG. 5, it can be seen that the drive waveform W1 according to the first embodiment is less likely to cause occurrence of air bubbles and an ejection failure as compared with the drive waveform W0 according to the comparative example.

Although one embodiment has been described above in detail, the disclosure is not limited to the above-described embodiment, and modifications, improvements, and the like can be made as appropriate.

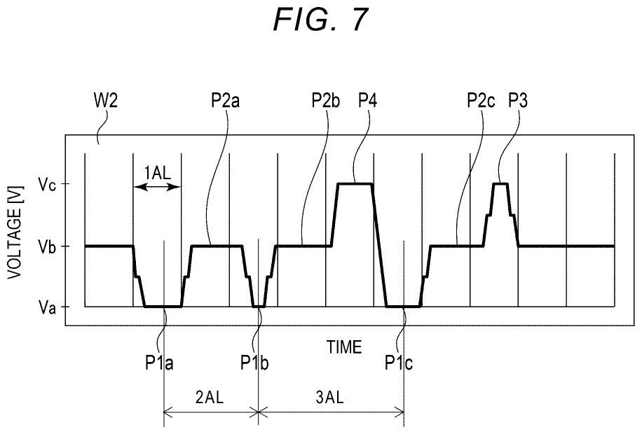

For example, although an example in which the plurality of ejection waveforms are trapezoidal waveforms having the same pulse width has been described in the embodiment described above, the disclosure is not limited thereto. For example, as illustrated in FIG. 7, which shows another embodiment, a step waveform for switching a voltage in a stepwise manner may be used, or a rectangular waveform in which there is no step and rising or falling of the waveform is steep may be used. In addition, pulse widths of the plurality of ejection pulses may be different. FIG. 7 illustrates a drive waveform W2 according to another embodiment. In FIG. 7, a vertical axis represents voltage [V], and a horizontal axis represents time [μs]. Note that each waveform diagram in FIG. 7 is marked with grid lines at intervals of one acoustic length (AL). Here, AL is a time of a half of a natural vibration cycle of ink in the pressure chamber 31 of the ink jet head 1.

The drive waveform W2 includes a plurality of ejection pulses P1a to P1c, holding elements P2a to P2c, a cancellation pulse P3, and a contraction pulse P4. Similar to the drive waveform W1, the drive waveform W2 is a multi-drop drive waveform having three drop waveforms in one printing cycle.

In the drive waveform W2 according to the present embodiment, each of the ejection pulses P1a, P1b, and P1c, the cancellation pulse P3, and the contraction pulse P4 is a step waveform for switching the voltage in a stepwise manner. In the drive waveform W2, a pulse width of the second ejection pulse P1b is smaller than that of the first ejection pulse P1a. In addition, the third ejection pulse P1c in the drive waveform W2 is a pulse waveform for reducing the voltage from the contraction voltage to the extended voltage and returning the voltage to the standby voltage in a stepwise manner after a certain time. In W2 according to the present embodiment, a time between the center of the ejection pulse P1a and the center of the ejection pulse P1b is twice AL, that is, 2 ALs. On the other hand, a time between the center of the ejection pulse P1b and the center of the ejection pulse P1c is three times AL, that is, 3 ALs, or about 3 ALs. That is, a cycle between ejection waveforms of the second drop and the third drop is longer than a cycle between ejection waveforms of the first drop and the second drop. Other configurations are the same as those of the drive waveform W1 according to the first embodiment.

In the drive waveform W2 according to the present embodiment, the meniscus can be stabilized by applying the contraction pulse P4 after the holding element P2b after the second ejection pulse P1b and before the application of the ejection pulse P1c for the third droplet, and an ejection failure can be prevented by applying the ejection pulse P1c after the contraction pulse P4.

For example, the ink jet head 1 including the driver IC is exemplified as an example of the drive device in the embodiment described above, the disclosure is not limited thereto. For example, various control devices such as a control device of an ink jet recording device connected to the ink jet head 1 and provided outside the ink jet head 1 may be used as the drive device.

Each potential of the drive waveform may be changed, and a voltage value applied to each piezoelectric element may be appropriately adjusted according to various conditions. The piezoelectric element may be configured to expand when a voltage is increased and contract when the voltage is reduced, or may be configured to expand when the voltage is reduced and contract when the voltage is increased. The order of expansion and contraction in each ejection pulse may also be appropriately set according to various conditions.

The structure of the ink jet head 1 is not limited to the above example, and the ink jet head 1 may be used in a head of another type. For example, the ink jet head is not limited to a structure in which the vibration plate provided between the pressure chamber and the drive element portion vibrates due to deformation of a drive element portion, and can be applied to various other structures such as a type in which the pressure chamber is formed between a plurality of columnar drive element portions.

The ink jet head may be a non-circulation type head that does not circulate ink, or may be a circulation type head that circulates ink.

According to at least one embodiment described above, the ejection performance can be improved by preventing trapping in a nozzle.

While certain embodiments have been described, these embodiments have been presented by way of example only and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. A liquid ejection device comprising:
a nozzle;
a pressure chamber that is capable of storing liquid and communicates with the nozzle, a volume of the pressure chamber being varied to eject the liquid from the nozzle;
a piezoelectric element configured to vary the volume of the pressure chamber in response to a drive signal; and
a drive circuit configured to generate the drive signal, wherein the drive signal includes:
a first ejection waveform that causes the liquid to be ejected from the nozzle,
a first holding waveform that is subsequent to the first ejection waveform and maintains the volume of the pressure chamber for a first time period,
a second ejection waveform that is subsequent to the first holding waveform and causes the liquid to be ejected from the nozzle,
a second holding waveform that is subsequent to the second ejection waveform and maintains the volume of the pressure chamber for a second time period,
a contraction waveform that is subsequent to the second holding waveform and contracts the pressure chamber,
a third ejection waveform that is subsequent to the contraction waveform and causes the liquid to be ejected from the nozzle, and
a third holding waveform that is subsequent to the third ejection waveform and maintains the volume of the pressure chamber for a third time period, and
a time between the center of the second ejection waveform and the center of the third ejection waveform is longer than a time between the center of the first ejection waveform and the center of the second ejection waveform.

2. The liquid ejection device according to claim 1, wherein
the time between the center of the first ejection waveform and the center of the second ejection waveform is 2 ALs, and the time between the center of the second ejection waveform and the center of the third ejection waveform is 3 ALs, where AL is half of a main acoustic resonance cycle of the liquid in the pressure chamber.

3. The liquid ejection device according to claim 2, wherein
each of the first, second, and third periods is shorter than 1 AL.

4. The liquid ejection device according to claim 1, wherein
the third holding waveform maintains a reference voltage or a contraction voltage applied to the piezoelectric element by the third ejection waveform.

5. The liquid ejection device according to claim 1, wherein
at least one of the first, second, and third ejection waveforms, the first, second, and third holding waveforms, and the contraction waveform is a step waveform that changes a voltage applied to the piezoelectric element in a stepwise manner.

6. The liquid ejection device according to claim 1, wherein
the first ejection waveform causes a voltage applied to the piezoelectric element to drop from a first voltage to a second voltage, and then rise from the second voltage back to the first voltage.

7. The liquid ejection device according to claim 6, wherein
the second ejection waveform causes the voltage applied to the piezoelectric element to drop from the first voltage to the second voltage, and then rise from the second voltage back to the first voltage.

8. The liquid ejection device according to claim 6, wherein
the contraction waveform causes the voltage applied to the piezoelectric element to rise from the first voltage to a third voltage, and then drop from the third voltage back to the first voltage.

9. The liquid ejection device according to claim 8, wherein
the third ejection waveform causes the voltage applied to the piezoelectric element to drop from the first voltage to the second voltage, and then rise from the second voltage to the third voltage.

10. The liquid ejection device according to claim 9, wherein
the drive signal includes a cancel waveform that is subsequent to the third holding waveform and causes the voltage applied to the piezoelectric element to rise from the third voltage to a fourth voltage, and then drop from the fourth voltage to the first voltage.

11. An ink jet head comprising:
a nozzle plate having a plurality of nozzles;
a plurality of pressure chambers that are capable of storing ink and respectively communicate with the nozzles, a volume of each pressure chamber being varied to eject the ink from the corresponding nozzle;
a plurality of actuators each configured to vary a volume of a corresponding one of the pressure chambers in response to a drive signal; and
a drive circuit configured to generate the drive signal, wherein the drive signal includes:
a first ejection waveform that causes the ink to be ejected from the nozzle,
a first holding waveform that is subsequent to the first ejection waveform and maintains the volume of the pressure chamber for a first time period,
a second ejection waveform that is subsequent to the first holding waveform and causes the ink to be ejected from the nozzle,
a second holding waveform that is subsequent to the second ejection waveform and maintains the volume of the pressure chamber for a second time period,
a contraction waveform that is subsequent to the second holding waveform and contracts the pressure chamber,
a third ejection waveform that is subsequent to the contraction waveform and causes the ink to be ejected from the nozzle, and
a third holding waveform that is subsequent to the third ejection waveform and maintains the volume of the pressure chamber for a third time period, and
a time between the center of the second ejection waveform and the center of the third ejection waveform is longer than a time between the center of the first ejection waveform and the center of the second ejection waveform.

12. The ink jet head according to claim 11, wherein
the time between the center of the first ejection waveform and the center of the second ejection waveform is 2 ALs, and the time between the center of the second ejection waveform and the center of the third ejection waveform is 3 ALs, where AL is half of a main acoustic resonance cycle of the ink in the pressure chamber.

13. The ink jet head according to claim 12, wherein
each of the first, second, and third periods is shorter than 1 AL.

14. The ink jet head according to claim 11, wherein
the third holding waveform maintains a reference voltage or a contraction voltage applied to the actuator by the third ejection waveform.

15. The ink jet head according to claim 11, wherein
at least one of the first, second, and third ejection waveforms, the first, second, and third holding waveforms, and the contraction waveform is a step waveform that changes a voltage applied to the actuator in a stepwise manner.

16. The ink jet head according to claim 11, wherein
the first ejection waveform causes a voltage applied to the actuator to drop from a first voltage to a second voltage, and then rise from the second voltage back to the first voltage.

17. The ink jet head according to claim 16, wherein
the second ejection waveform causes the voltage applied to the actuator to drop from the first voltage to the second voltage, and then rise from the second voltage back to the first voltage.

18. The ink jet head according to claim 16, wherein
the contraction waveform causes the voltage applied to the actuator to rise from the first voltage to a third voltage, and then drop from the third voltage back to the first voltage.

19. The ink jet head according to claim 18, wherein
the third ejection waveform causes the voltage applied to the actuator to drop from the first voltage to the second voltage, and then rise from the second voltage to the third voltage.

20. The ink jet head according to claim 19, wherein
the drive signal includes a cancel waveform that is subsequent to the third holding waveform and causes the voltage applied to the actuator to rise from the third voltage to a fourth voltage, and then drop from the fourth voltage to the first voltage.
